(19) United States
(12) Patent Application Publication
(10) Pub. No.: US 2011/0163069 A1
(43) Pub. Date: Jul. 7, 2011

(54) GAS-INSULATED HIGH-VOLTAGE SWITCH

(75) Inventors: Daniel Ohlsson, Wettingen (CH); Martin Kriegel, Ehrendingen (CH); Navid Mahdizadeh, Baden (CH); Timo Kehr, Birrhard (CH)

(73) Assignee: ABB RESEARCH LTD, Zuerich (CH)

(21) Appl. No.: 12/983,035

(22) Filed: Dec. 31, 2010

(30) Foreign Application Priority Data
Jan. 6, 2010 (EP) 10150168.2

(51) Int. Cl. H01H 33/867

(52) U.S. Cl. 218/66

(57) ABSTRACT

The high-voltage switch exhibits a compression space of small dimensions, in which, on interruption of a current, insulating gas exhibiting quenching characteristics is compressed mechanically to form quenching gas with the aid of an operating mechanism of the switch. When a small current is interrupted, a sufficient quantity of quenching gas can thus be provided with little mechanical operating force. When a large current is interrupted, quenching gas communicates from the compression space into an expansion volume above a response pressure, keeping the operating force low, of a pressure relief valve. A large quantity of quenching gas is then available for successfully interrupting a large current whilst the operating force is kept low.

### TECHNICAL FIELD

The present invention relates to a high-voltage switch as claimed in the preamble of patent claim 1.

A switch of the aforementioned type is generally a circuit breaker which controls breaking currents of over 10 kA within a voltage range of over 70 kV. Such a switch has a breaker enclosure which is filled with an insulating gas exhibiting arc quenching characteristics, for instance based on sulfur hexafluoride and/or nitrogen and/or carbon dioxide at a pressure of generally up to a few bar. To achieve a rapid dielectric recovery of a contact gap formed between the opening contact members during the breaking of a current, a quenching gas which is generated by compression of insulating gas in a piston/cylinder compression device, activated by the operating mechanism of the switch is blown onto an arcing zone accommodating the switching arc. During the breaking of large short-circuit currents, quenching gas stored in a heating volume, which is compressed due to the thermal effect of the switching arc, is additionally used.

### PRIOR ART

A switch of the type initially mentioned is described by way of example in U.S. Pat. No. 6,207,917 B1, JP 2003-197076 A, DE 199 10 166 A1 or DE 197 36 708 C1. The switches described in each case contain an enclosure filled with an insulating gas exhibiting arc quenching characteristics and forming a storage space for the insulating gas, and an operating mechanism. In the enclosure, a contact arrangement can be activated by the operating mechanism and a heating volume and a piston/cylinder compression device coupled non-positively to the contact arrangement are arranged. The heating volume and the compression space of the compression device are connected to one another via a non-return valve and communicate with one another if the pressure in the compression space is higher than in the heating volume. If the pressure in the compression space exceeds a predetermined pressure limit value, as is generally the case when interrupting a large short-circuit current, a pressure relief valve responds and after the response compressed insulating gas is expanded from the compression space into the storage space. The energy expended by the operating mechanism for compressing the expanded gas is therefore not used for generating quenching gas. To provide an adequate amount of quenching gas, nevertheless, either the compression space must have a large capacity or the operating mechanism must be very powerful in order not to become blocked at high pressure peaks.

### DESCRIPTION OF THE INVENTION

The invention as specified in the patent claims is based on the object of creating a switch of the type initially mentioned which is distinguished by a good switching capability in spite of a weakly designed operating mechanism.

The high-voltage switch according to the invention, defined in patent claim 1, contains the following components:

an enclosure filled with an insulating gas exhibiting arc quenching characteristics, which confines a storage space for the insulating gas,

a contact arrangement held in the enclosure, comprising two contact members which are moved relative to one another along an axis with the aid of an operating mechanism during a switching process,

a heating volume attached to the first of the two contact members, configured annularly around a hollow arc contact of the first contact member and used for accommodating switching arc gases, which during the breaking communicates with an arcing zone accommodating the switching arc,

a piston/cylinder compression device activated by the first contact member during the breaking, comprising a compression space configured annularly around the hollow arc contact for accommodating compressed insulating gas,

a first non-return valve arranged in the heating volume, by means of which insulating gas is conducted from the compression space into the heating volume,

a first pressure relief valve for limiting the pressure of the compressed insulating gas in the compression space,

a second non-return valve arranged in the compression space, by means of which insulating gas is conducted into the compression space during switch-on, and at least one first expansion volume used for accommodating compressed gas, which communicates with the compression volume after the opening of the first pressure relief valve and is then blocked with respect to the storage space by a third non-return valve.

In the switch according to the invention, the compression volume is of small dimensions and can thus provide a quantity of compressed insulating gas used as quenching gas which is sufficient for a successful thermal blow-out of the switching arc with a low operating force when interrupting a low current. When a large current is interrupted, insulating gas, compressed above a response pressure of the first pressure relief valve keeping the operating force low, from the compression space communicates into the expansion volume. A greater quantity of quenching gas is then available for the thermal blow-out of the switching arc than when a small current is interrupted with the operating force being kept low and the arcing zone can thus be successfully dielectrically recovered even when a large current is interrupted.

In order to limit the pressure in the first expansion volume, a second pressure relief valve can be provided.

The first expansion volume can be connected directly to the storage space via the second pressure relief valve. As an alternative, the first expansion volume can be connected directly to a second expansion volume via the second pressure relief valve.

The second expansion volume can be connected directly to the storage space or to a third expansion volume via a third pressure relief valve.

At a hollow cylinder radially confining the compression space toward the outside, at least two axially spaced-apart cylinder bottoms can be attached, the first one of which separates the compression space and the first expansion volume from one another and, together with the second cylinder bottom, determines the height of the first expansion volume extended along the axis. The first pressure relief valve and the second non-return valve can be held at the first cylinder bottom, a second pressure relief valve and the third non-return valve can be held at the second cylinder bottom. At the hollow cylinder, at least one third cylinder bottom can be attached which, together with the second cylinder bottom, determines the height of a second expansion volume extended along the axis and holds a fourth non-return valve and a possibly provided third pressure relief valve.

### BRIEF DESCRIPTION OF THE DRAWINGS

In the text which follows, the invention will be explained in greater detail with reference to drawings, in which:

FIG. 1 shows a top view of a section conducted along an axis A through a first embodiment of a high-voltage switch according to the invention, in which the switch is closed on the left of the axis and just interrupts a small current on the right of the axis,

FIG. 2 shows the switch according to FIG. 1 when interrupting a large current, and

FIG. 3 shows a second embodiment, modified with respect to the first embodiment, of the high-voltage switch according to the invention.

### APPROACHES TO CARRYING OUT THE INVENTION

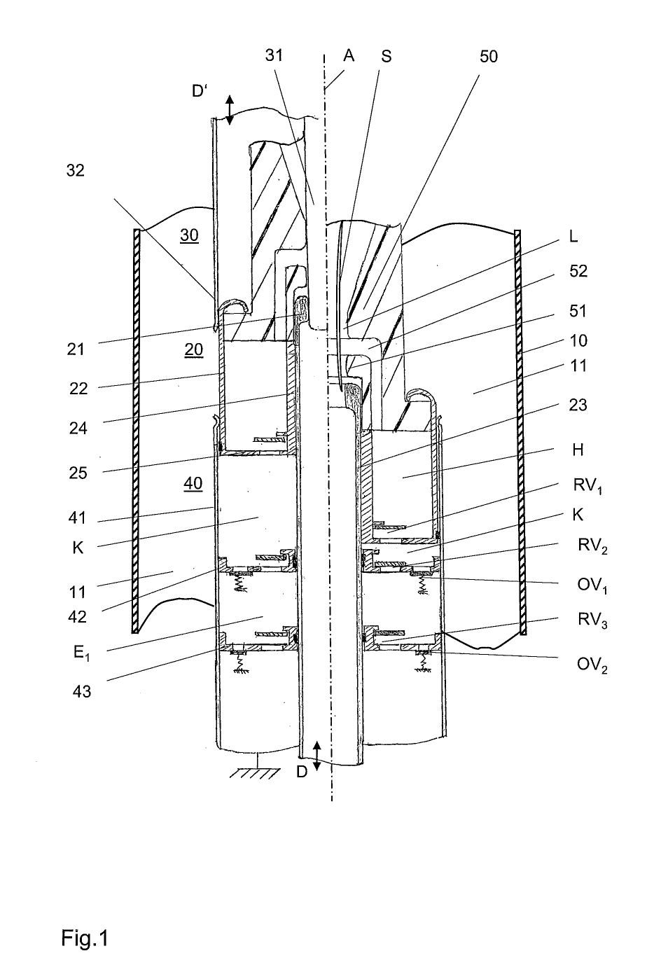

In all figures, identical reference symbols also designate identically acting parts. The two embodiments of the high-voltage switch according to the invention, shown in FIGS. 1 to 3, are in each case constructed as circuit breakers and in each case contain a largely tubular enclosure 10 and a largely axially symmetrically designed contact arrangement, accommodated by the enclosure 10, comprising two contact members 20 and 30 which are displaceable relative to one another along an axis A.

The enclosure 10 is filled with a compressed insulating gas, for instance based on sulfur hexafluoride or a gas mixture containing sulfur hexafluoride, and thus forms a storage space 11 for the insulating gas. The contact member 20 exhibits a hollow arc contact 21 and a hollow rated-current contact 22 surrounding the hollow arc contact in a coaxial arrangement, whereas the contact member 30 contains an arc contact 31 constructed as a pin and a hollow rated-current contact 32 surrounding the arc contact 31 in a coaxial arrangement.

The contact member 20 is carried in a gas-tight sliding manner along the axis A in a fixed metal hollow body 40 and connected via a hollow contact carrier 23 of the arc contact 21 to an insulator, not shown, of an operating mechanism D of the switch which is at ground potential.

The hollow body 40 contains an axially aligned fixed hollow cylinder 41 coaxially enclosing the rated-current contact 22 and two cylinder bottoms 42, 43 which are attached in a mutually axially offset manner at the inside wall of the hollow cylinder 41. In the cylinder bottoms, a central opening is in each case provided in which the hollow contact carrier 23 of the arc contact 21 is supported in a gas-tight manner, retaining its axial displaceability.

On the outside surface of the contact carrier 23 a metal sleeve 24 is attached which carries at its end facing the contact member 30 an auxiliary nozzle 51 consisting of insulating material such as PTFE. This insulating auxiliary nozzle surrounds the arc-resistantly constructed free end of the arc contact 21. The end of the sleeve 24 facing the operating mechanism D is constructed as a wall 25 carried radially outward. At the outer edge of the wall 25, the hollow-cylindrically constructed rated-current contact 22 is arranged. This contact is evidently connected jointlessly to the outer edge of the wall but can also be joined directly at the edge of the wall 25. The end of the rated-current contact 22 facing the contact member 30 carries on its inside an insulating nozzle 50 typically containing PTFE, the constriction of which is closed by the arc contact 31 when the switch is closed.

The sleeve 24, the wall 25, the rated-current contact 22 and the end, held in the rated-current contact 22, of the insulating nozzle 50 confine a heating volume H for accommodating hot ionized gas which is generated by a switching arc S produced when the switch is opened. The heating volume H communicates via a heating duct 52 confined by the insulating nozzle 50 and the auxiliary insulating nozzle 51, with an arcing zone L confined radially by the constriction and the diffuser of the insulating nozzle 50 and axially by the two opened arc contacts 21 and 31, accommodating the switching arc S.

The rated-current contact 22 slides in a gas-tight and electrically conductive manner in the hollow cylinder 41. The hollow cylinder 41, the cylinder bottom 42, the contact carrier 23 and the wall 25 of the sleeve 24 therefore confine a compression space K of a piston/cylinder compression device with a fixed hollow cylinder formed by the parts 41 and 42 and a piston formed by the parts 23 and 25 and moved by the operating mechanism D. The compression space K communicates with the heating volume H via a non-return valve RV₁ arranged in the wall 25 if the pressure in the compression space K is equal to or higher than in the heating volume H.

The two cylinder bottoms 42 and 43 held fixed spaced apart in the axial direction from one another in the hollow cylinder 41 confine an expansion volume E₁ configured annularly around the axis A or the contact carrier 23, respectively, the height of which is determined by the aforementioned axial distance. In the cylinder bottom 42, a non-return valve RV₂ and a pressure relief valve OV₁ are arranged and in the cylinder bottom 43, a non-return valve RV₃ and a pressure relief valve OV₂ are arranged.

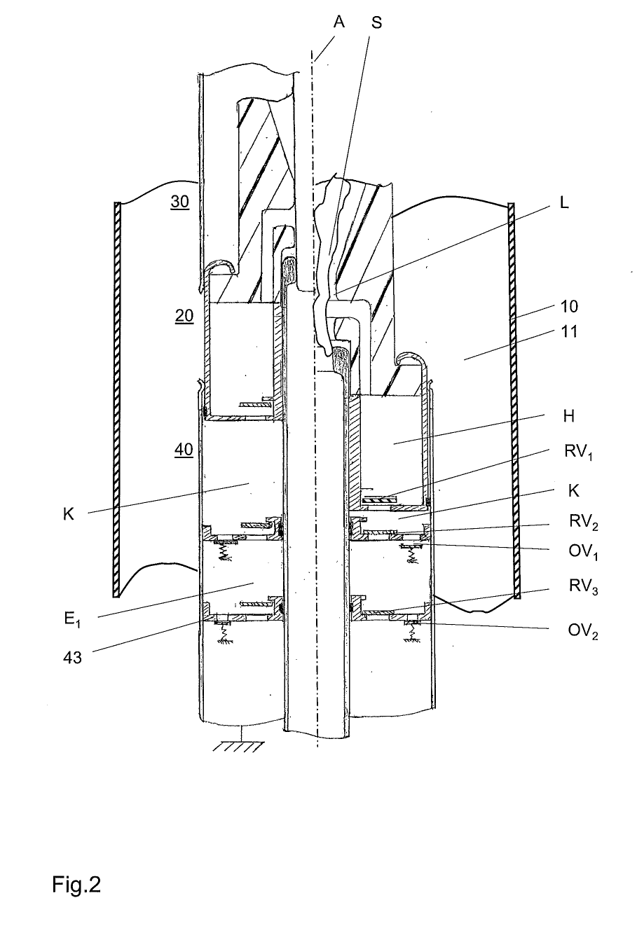

The switch according to FIGS. 1 and 2 acts as follows: if the switch is closed—as shown in the left-hand half of FIG. 1 and FIG. 2, respectively, the non-return valves RV₁, RV₂ and RV₃ are opened. The heating volume H, the compression space K and the expansion volume E₁ therefore communicate with the storage space 11 and these spaces are filled with fresh insulating gas.

When a current is broken, the two contact members 20, 30 are separated and a switching arc S burning in the arcing zone L forms between the two arc contacts 21, 31. Arc gases generated by the switching arc flow through the diffuser of the insulating nozzle 50 and the hollow arc contact 21 into the storage space 11, but also pass via the heating duct 52 into the heating volume H and they are mixed with the insulating gas already present there to form (compressed) quenching gas (FIGS. 1 and 2, right-hand half in each case).

If only a small current is switched off, the heating power of the switching arc S is generally not sufficient for being able to successfully interrupt the current. The pressure built up in the heating volume H by the switching arc S is then too small for successfully being able to blow out the switching arc S with the quenching gas present in the heating volume, and thus interrupting the current, at the zero transition of the current to be switched off.

In contrast, a sufficiently high pressure is generated with the aid of the piston/cylinder compression device. As is shown in the right-hand half of FIG. 1, the size of the compression space K is reduced due to the downward movement of the contact carrier 23 and the associated piston formed by the wall 25 and the contact carrier 23 during the breaking. This reduction in size is also achieved if a force introduced by an operating mechanism D′ into the contact member 30 during the breaking, is transferred to the contact member 20 via an angle gear connected to the contact member 30 and the insulating nozzle 50. In each case, the pressure of the insulating gas located in the compression space K is increased during the breaking and closes the non-return valve RV₂. Since the pressure of the gas present in the heating volume H is not significantly increased because of the low quantity of inflowing gas from the arcing zone L, the non-return valve RV₁ remains opened, in contrast, and the heating volume H and the compression space K communicate with one another. Compressed insulating gas therefore flows from the compression space K into the heating volume H and passes via the heating duct 52 into the arcing zone L. In this manner, a quenching gas is provided, the quantity, pressure and quality of which are sufficient for cooling the switching arc S to a sufficiently strong degree by thermal blow-out at the zero transition and correspondingly successfully interrupting the current.

The build up of the quenching gas taking place due to mechanical forces is dependent on the size of the compression space K. With a predetermined stroke of the piston of the compression device or of the operating mechanism D, D′, respectively, and with a predetermined size of the heating volume H, a higher pressure accordingly builds up in the quenching gas when using a small-dimensioned compression space K than when a larger-dimensioned compression space K is used. Since only a small amount of sufficiently compressed quenching gas is needed for the successful interruption of a small current, the size of the compression space K can be kept relatively small.

When breaking a large current, the pressure build-up is much greater in the heating volume H than in the compression space K because of the strong heating effect of the switching arc S. The non-return valve RV₁ therefore also closes now. If the pressure in the compression space K exceeds a predetermined limit value, the pressure relief valve OV₁ opens. After the opening, the compression space K communicates with the expansion volume E₁ via this pressure relief valve and thus limits the pressure in the compression space K. As shown in the right-hand half of FIG. 2, the compressed insulating gas streaming into the expansion volume E₁ from the compression space K increases the insulating gas pressure in the expansion volume E₁, and ensures that the non-return valve RV₃ closes.

When the zero transition of the current is approached, the pressure in the heating volume H drops. The non-return valve RV₁ opens as soon as the pressure in the compression space K and in the expansion volume E₁ communicating with it is greater than the pressure in the heating volume H. Compressed quenching gas now flows from the compression space K enlarged by the expansion volume E₁ via the heating volume H and the heating duct 52 into the arcing zone L. Quantity, pressure and quality of the quenching gas thus provided are sufficient for cooling the switching arc S sufficiently strongly by thermal blow-out at the zero transition of the current and thus successfully interrupting the large current.

When switching a large current, the expansion volume E₁ therefore increases the relatively small capacity of the compression space K optimized for switching off small currents. There is therefore more quenching gas available for cooling the powerful arc produced when interrupting a large current than when a small current is interrupted. Since this quenching gas is achieved by the large capacity of the compression space K enlarged by the expansion volume E₁ and not by an excessively high pressure in the compression space K, a high pressure reacting on the operating mechanism is thus avoided. In addition, it is thus avoided that when a large current is interrupted, compressed insulating gas is conducted from the compression space K directly into the storage space 11. The operating mechanism of the switch can therefore be advantageously dimensioned to be smaller than in the case of a switch according to the prior art.

On switch-on, the contact carrier 23 and therefore also the piston of the compression device are moved upward. During this process, underpressure is produced in the compression space K and fresh insulating gas is sucked from the storage space 11 via the opened non-return valves RV₃ and RV₂ into the expansion volume E₁ and into the compression space K.

The pressure relief valve OV₂ limits the pressure in the expansion volume E₁. If this pressure exceeds a predetermined response value which is typically equal to or slightly larger than the corresponding response value of the pressure relief valve OV₁, it opens. After the opening, the expansion volume E₁ communicates directly with the storage space 11 and thus limits the pressure in the compression space K.

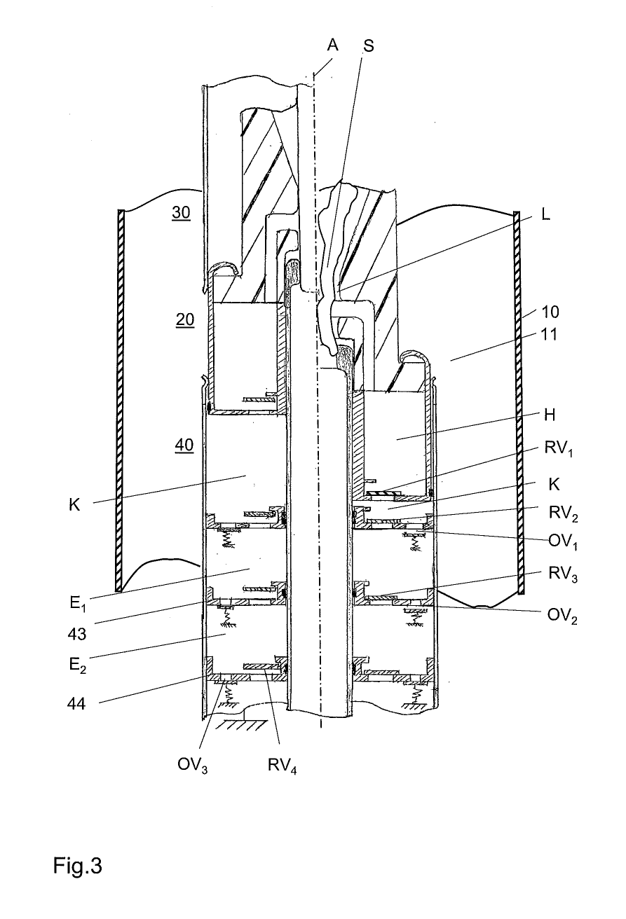

In the second embodiment of the switch according to the invention apparent from FIG. 3, a cylinder bottom 44 is additionally attached at the hollow cylinder 41, which, together with the cylinder bottom 43, determines the height of an expansion volume E₂ aligned along the axis A. In the cylinder bottom 44, a non-return valve RV₄ and a pressure relief valve OV₃ are arranged.

If the pressure in the expansion volume E₁ exceeds a predetermined response pressure, during the interruption of a large current, the pressure relief valve OV₂ also opens as is shown in the right-hand half of FIG. 3. After the opening of this valve, the expansion volume E₁ communicates with the expansion volume E₂ and thus limits the pressure in the expansion volume E₁. At the same time, the compressed insulating gas flowing into the expansion volume E₂ increases the insulating gas pressure in the expansion volume E₂ and ensures that the non-return valve RV₄ closes.

The response pressure of the pressure relief valve OV₂ is generally equal to the response value of the pressure relief valve OV₁. In the case of a particularly powerful switching arc S, an additional quantity of quenching gas can thus still be provided compared with the embodiment according to FIG. 1.

The pressure relief valve OV₃ limits the pressure in the expansion volume E₂. If this pressure exceeds a predetermined response value, which is typically equal to or slightly larger than the corresponding response value of the pressure relief valve OV₂, it opens. After the opening, the expansion volume E₂ communicates directly with the storage space 11 or with a possibly provided further expansion volume and thus limits the pressure in the expansion volume E₂.

The pressure relief valves OV₁, OV₂, OV₃ can have different response pressures so that a different number of expansion volumes can be progressively added depending on the current intensity or, respectively, the pressure build-up in the heating volume H, respectively, or depending on the prevailing conditions on interrupting the current to be switched off. As shown in the exemplary embodiments, the compression space K and the expansion volume E₁ or the expansion volumes E₁, E₂, respectively, and possibly predetermined other expansion volumes are lined up along the axis A. As an alternative, at least one first one of the expansion volumes can comprise the compression space K and/or a second one of the expansion volumes coaxially. The valves, e.g. RV₂ and OV₁, located between the adjoining spaces, e.g. K and E₁, can then be arranged in an axially aligned wall, e.g. the hollow cylinder 41.

### LIST OF REFERENCE DESIGNATIONS

10 Switch enclosure
11 Storage space
20 Contact member
21 Arc contact
22 Rated-current contact
23 Contact carrier of the arc contact 21
24 Sleeve
25 Wall
30 Contact member
31 Arc contact
32 Rated-current contact
40 Hollow body
41 Hollow cylinder
42, 43, 44 Cylinder bottoms
50 Insulating nozzle
51 Insulating auxiliary nozzle
52 Heating duct
A Axis
D, D′ Switch operating mechanisms
E₁, E₂ Expansion volumes
H Heating volumes
K Compression space
L Arcing zone
OV₁, OV₂, OV₃ Pressure relief valves
RV₁, RV₂, RV₃, RV₄ Non-return valves
S Switching arc

1. A high-voltage switch, comprising:
an enclosure filled with an insulating gas exhibiting quenching characteristics, which confines a storage space for the insulating gas;
a contact arrangement held in the enclosure, having first and second contact members for movement relative to one another along an axis (A) via an operating mechanism during a switching process;
a heating volume attached to the first contact member, configured annularly around a hollow arc contact of the first contact member for accommodating arc gases, which during breaking communicates with an arcing zone accommodating a switching arc;
a piston/cylinder compression device activated by the first contact member during the breaking, having a compression space configured annularly around the hollow arc contact for providing compressed insulating gas;
a first non-return valve arranged in the heating volume for conducting insulating gas from the compression space into the heating volume;
a first pressure relief valve for limiting pressure of the compressed insulating gas in the compression space;
a second non-return valve arranged in the compression space for conducting insulating gas into the compression space during switch-on;
at least one first expansion volume for accommodating compressed insulating gas, and for communicating with the compression volume after opening of the first pressure relief valve; and
a third non-return valve for blocking the first expansion volume with respect to the storage space.

2. The switch as claimed in claim 1, comprising:
a second pressure relief valve for limiting pressure in the first expansion volume.

3. The switch as claimed in claim 2, wherein the first expansion volume is connected directly to the storage space via the second pressure relief valve.

4. The switch as claimed in claim 2, wherein the first expansion volume is connected directly to a second expansion volume via the second pressure relief valve.

5. The switch as claimed in claim 4, wherein the second expansion volume is connected directly to the storage space or to a third expansion volume via a third pressure relief valve.

6. The switch as claimed in claim 5, comprising:
a hollow cylinder radially confining the compression space; and
at least first and second axially spaced-apart cylinder bottoms, the first axially spaced-apart cylinder bottom being located for separating the compression space and the first expansion volume from one another and, together with the second axially spaced-apart cylinder bottom, determining a height of the first expansion volume extended along the axis (A).

7. The switch as claimed in claim 6, wherein the first pressure relief valve and the second non-return valve are held at the first axially spaced-apart cylinder bottom, and the second pressure relief valve and the third non-return valve are held at the second axially spaced-apart cylinder bottom.

8. The switch as claimed in claim 7, wherein at the hollow cylinder, at least one third cylinder bottom is attached which, together with the second axially spaced-apart cylinder bottom, determines a height of the second expansion volume extended along the axis (A), and holds a fourth non-return valve and the third pressure relief valve.

9. The switch as claimed in claim 5, comprising:
a hollow cylinder radially confining the compression space; and
at least first and second axially spaced-apart cylinder bottoms, the first axially spaced-apart cylinder bottom being located for separating the compression space and the first expansion volume from one another and, together with the second axially spaced-apart cylinder bottom, determining a height of the first expansion volume extended along the axis (A).
